(19) United States
(12) Patent Application Publication
(10) Pub. No.: US 2014/0280484 A1
(43) Pub. Date: Sep. 18, 2014

(54) Dynamic Service Extension Infrastructure For Cloud Platforms

(71) Applicants: Oliver Klemenz, Walldorf (DE); Gregor Karl Frey, Walldorf (DE); Ulrich Bestfleisch, Walldorf (DE); Holger Knospe, Walldorf (DE)

(72) Inventors: Oliver Klemenz, Walldorf (DE); Gregor Karl Frey, Walldorf (DE); Ulrich Bestfleisch, Walldorf (DE); Holger Knospe, Walldorf (DE)

(21) Appl. No.: 13/838,134

(22) Filed: Mar. 15, 2013

(51) Int. Cl. H04L 29/08

(52) U.S. Cl. CPC H04L 67/10
USPC 709/203

(57) ABSTRACT

DSEI (dynamic service extension infrastructure) enables registration of an extension application as a service, storage of application files and development resources, runtime access to runtime artifacts, generic data persistency, Web enablement of application maintenance and persistence access, and so on. An integrated development environment that supports file access may be used for the creation of application service. DSEI provides a WebDAV folder for each extension application, so that the user may work on the application files and resources. Application services may be built with standard Web technologies. It is possible without knowing the technical infrastructure of a cloud application in the cloud platform, to extend the cloud application by creating application services or to enhance existing application services.

### FIELD

The field generally relates to the software arts, and, more specifically, to methods and systems including a dynamic service extension infrastructure for cloud platforms.

### BACKGROUND

Cloud computing provides hardware and software resources as a service to users over a network. There are different types of cloud computing such as: Platform-as-a-Service (PaaS), Infrastructure-as-a-Service (IaaS), Software-as-a-Service (SaaS), and so on. The PaaS enables users to deploy, configure, and use business applications in a cloud environment. Further, the users are provided with the possibility to create software solutions using tools and libraries from the cloud provider. The cloud provider provides the required tools, infrastructure, and services needed to get user's on-demand applications up and running Developers can use the platform to build lightweight and network-oriented applications to extend already existing solutions.

Typically, cloud providers install and operate the application software in the cloud and the cloud users access the applications software from cloud clients. The cloud users do not manage the cloud infrastructure and platform on which the application is running. This eliminates the need to install and run the application on the cloud user's own computer. Thus, maintenance and support of the hardware and application software is simplified. The IaaS providers offer physical machines, virtual machines, servers, storage units, networks, and other resources. The IaaS providers supply these resources on-demand from data centers. In general, cloud providers define the costs for using their resources based on the amount of resources allocated and consumed.

Nowadays, software is preferably provided to customers as cloud applications that are hosted by cloud providers and offered on-demand to the users. A main characteristic of a cloud application is that its technical details are concealed for the customer. The development technology and development platform are not visible to the cloud application users. Further, standard business applications can only offer limited out of the box functionalities that work immediately after installation without any configuration or modification. Therefore, third party partners have specialized in providing expertise in very specific topics and filling in the gaps between the customer specific development and the standard application software delivered by the software provider.

However, not always third party partners are involved. Larger companies and organizations may prefer to perform extensions to the business software themselves instead of using third parties' services. In these cases, technical trained developers may not be available and the business users will need to do the software application enhancements themselves. In some cases even students or interns may be engaged to provide such application development. Therefore, extensions to the standard software should be possible by non-developers as well.

### SUMMARY

Various embodiments of systems and methods for dynamic service extension infrastructure for cloud platforms are described herein. In various embodiments, the method includes creating an extension application of type service for a cloud application running on an application server of a cloud platform. The method also includes registering the extension application as a service in a service registry of a dynamic service extension infrastructure (DSEI) as part of the cloud platform. Further, a plurality of resource files of the extension application is stored in a storage module of the DSEI. Finally, a persistency datamodel of the extension application is stored in a persistency storage unit, wherein the datamodel includes at least one application entity and at least one application entity field for the application entity.

In various embodiments, the system includes a processor and a memory in communication with the processor. According to one aspect, the memory includes an application server running on a cloud platform and a dynamic service extension infrastructure (DSEI) as part of the application server, wherein the DSEI provides modules for creating an extension application of type service. The system also includes a service registry in the DSEI, wherein the extension application is registered as a service. In addition, a resource file storage unit is included that stores a plurality of resource files of the extension application.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a high-level architectural view of a dynamic service extension infrastructure, according to one embodiment.

FIG. 2 is a block diagram illustrating a detailed architectural view of a DSEI 115, according to one embodiment.

FIG. 3 is a flow diagram illustrating a process of enhancing an application service by an organization, according to one embodiment.

FIGS. 4A and 4B are flow diagrams illustrating a process of creating an application service by a third party partner, according to one embodiment.

FIGS. 5A and 5B are flow diagrams illustrating a process of creating an application service in the DSEI 115, according to one embodiment.

FIG. 6 is a flow diagram illustrating a process of consuming an application service, according to one embodiment.

FIG. 7 is a block diagram of an exemplary computer system 700, according to one embodiment.

### DETAILED DESCRIPTION

Embodiments of techniques for methods and systems including a dynamic service extension infrastructure for cloud platforms are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In the area of cloud computing, the development technology and development platform of a cloud application are not transparent to the outside world and the users are limited to consuming standard features and services provided with the application. Therefore, it would be beneficial to customers that are non-developers and may have little knowledge in the application development to be able to modify and enhance a business application. In various embodiments, a dynamic service extension infrastructure for cloud platforms is described enabling extensions to the standard business application. The dynamic service extension infrastructure (DSEI) is an extension environment that is a lightweight and easy-to-use extension kit for application enhancements. No new programming environment or new programming language may be needed for the customers to enhance a business application by adding extensions such as services. In various embodiments, the application enhancements rely on state-of-the-art already settled technologies such as Web technologies. Further, an easy-to-use file access to development resources is provided, for example, via the Web Distributed Authoring and Versioning (WebDav) protocol. The WebDav protocol facilitates collaboration between users in editing and managing documents and files stored on Web servers. The extension environment also supports easy-to-use application enhancement management and maintenance.

In various embodiments, the DSEI may provide standardized communication between clients and servers in an application enhancement using technologies such as REpresentational State Transfer (REST) and Open Data Protocol (OData). REST describes how distributed data objects, or resources, can be defined and addressed, emphasizing the easy exchange of information and scalability. The Open Data Protocol (OData) is a Web protocol for querying and updating data, used to expose and access information from a variety of sources including, but not limited to, relational databases, file systems, content management systems and traditional Web sites. In addition, the DSEI may provide generic and standardized persistence entities allowing CRUD (create, retrieve, update, delete) functions out of the box.

In various embodiments, an organization may need to extend the services of a business application that provides for the needs of its customers. An exemplary organization that may need to enhance its business applications is a city municipality. It should be noted that the city municipality is just an example of such an organization and that any type of organization or company can make use of the DSEI. In the example of a city municipality, the city municipality may want to offer different services to the citizens, but in the same time the city municipality may not be able to provide all the different types of services that the citizens may need. For example, a citizen may want to apply for a passport and would like to do that from the Web site of the city municipality, instead of going to the city office physically. For that purpose, the city municipality should have a business application and a specific service providing this possibility for the citizens. Although, this particular service may seem common, there may be plenty of other services specific to the needs of a given citizen. Therefore, the city municipality may not be able to cover all possible demands of its citizens.

In various embodiments, an organization (e.g., the city municipality) or a company provides a cloud application platform that offers a plurality of standard application services online to its customers (e.g., the citizens). A dynamic service extension infrastructure is included in the application platform architecture that allows the organization or other partners to modify or add new services to a deployed business application on the application platform. The DSEI is an extension environment established as an open framework where different parties (e.g., the city municipality itself, an external company that is partner with the city municipality, etc.) can register with the organization providing the application platform and develop new application services or extend existing services that are offered by the application platform. When third parties are involved in developing and provisioning of services, the maintenance and administration efforts for the organization are reduced. In addition, the dynamic service extension infrastructure allows parties with different technical background and knowledge about the development process to be able to enhance a given service or develop and offer additional on-demand services.

In various embodiments, the on-demand services provided by the organization or third party partners are cloud services (i.e., based on cloud computing). The cloud services represent different functionalities as part of cloud applications that are deployed on a cloud application platform. The cloud applications and the cloud platform are hosted on a cloud provider. The DSEI enables an organization or third party partners to enhance on-demand services on the cloud platform, hosted by the cloud provider. The DSEI enables the organization to virtualize step-by-step their customers' services and processes. In some embodiments, the built-in extensibility mechanism allows the organization to deliver service extensions and enhancements on its own without the support of external partners.

FIG. 1 is a block diagram illustrating a high-level architectural view of a dynamic service extension infrastructure, according to an embodiment. The DSEI may provide two types of extension mechanisms differing in the location of the development resources and the runtime artifacts of the cloud application: a service registry solution and an integral software development kit solution. In some embodiments, the organization or company (e.g., the city municipality) may already have the development knowledge and expertise to build new application services on an existing application platform. The service infrastructure provides a service registry, where the URL to the newly built applications can be entered. Additionally, the service infrastructure provides technical data services that can be called via Web technologies to request context information and to return the data back in a respective channel. In other embodiments, the organization or company (e.g., the city municipality) may not have the development knowledge, expertise, or the technical infrastructure to build new applications or extensions to services. In this case, the DSEI stores the development resources, provides the runtime artifacts, and offers a data persistency in addition to the service registry. The organization may use the DSEI to build enhancements to applications without needing all the technical development background how the cloud application was built by the software provider. For example, the development resources can be accessed and modified using WebDav approach by mounting a local file system to the file system of the software provider and copy the content of the cloud application from the software provider to the local file system.

In various embodiments, the DSEI may be integrated seamlessly into any business software on a cloud platform to provide basic functionalities including, but not limited to: 1) registration of an extension application as a service; 2) storage of application files and development resources; 3) runtime access to runtime artifacts; 4) generic data persistency; 5) Web enablement of application maintenance and persistence access; and so on.

System 100 illustrates a cloud platform 110 with an integrated dynamic service extension infrastructure (DSEI) 115. The cloud platform is hosted on a cloud provider such as SAP AG®. The DSEI 115 is a separate enhancement module of an application server running on the cloud platform 110. The application server includes a set of cloud applications that are provided in the cloud to customers such as the city municipality. The DSEI 115 enables service extensions to the applications to be created, registered, and maintained in the application server. Further, the DSEI 115 can be accessed by users (e.g., developers, third parties, etc.) via an entry portal such as a Web page. The entry portal provides an interface that enables the users to administer services, edit files, create and update persistent entities, and so on. In some embodiments, the entry portal interface may include a list of services that are of interest to a particular user. For example, the user may select a set of services to be displayed on his or her portal page. This set of services may be just a subset of a larger set of services that is available from the organization. Some of the services in the larger set of services may be provided by third party partners.

In various embodiments, the applications are not directly provided by the organization but are bundled in one application framework (such as the application server) deployed on the cloud platform. Thus, all applications in the application framework may have similar look-and-feel and may share some of the services (such as a security service, an authentication service, etc.) In this way, for example, if different users want to use same applications, the application framework manages the control and rights of the users over the applications and services. Further, every service may automatically run in an abstract security box. If a user deploys a service on the cloud application platform 110, then this service may also run automatically in the abstract security box. Thus, if a user accesses this service, the application framework may automatically check if the user is authenticated to use or consume this service and the extent of rights the user has. The common look-and-feel of the applications and the abstract security box concept facilitate the users to enhance the services and develop service extensions via the DSEI 115.

Going back to FIG. 1, an application 120 is created and deployed on the cloud platform 110. In various embodiments, the application 120 is the entry point for a user to consume a service. The application 120 may be of various types. The different types define how the application 120 is included into the software providers of the cloud application and how the application is shown to the application user. Some of the types may include, but are not limited to, service 125, news feed 130, or other types 135. The applications of type service can be registered with their Web URL in a service registry 140. It should be noted that the terms: an “application service”, a “service extension”, and a “service” have analogous meaning, this is “an extension application of type service”. Services may also be deployed as a mobile solution, or News Feed. These types of services may need a different registration in the service extension framework and may need a different integration and implementation in the application server to work. In various embodiments, application 120 may be registered in the service registry 140 via REST 145 protocol. The service registry 140 enables users to register a service extension by entering a URL pointing to an entry Web page of the application 120. The service registry 140 provides administration of the registered services, adding a new service, deleting a service, and so on. In this way, services that are developed from different parties in different locations can be registered in the service registry 140 and provisioned to the users. The users can then consume the services in the cloud.

DSEI 115 further includes a resource file storage 150 module, where design time artifacts are stored. In a typical development process of an application service, the design time artifacts are source code files developed during design time. These are the resource files needed to develop a service extension for the extension infrastructure. These resource files are of types conforming to the Web technology development specification, e.g., HTML, JavaScript files and resources such as images. During runtime, the resource files may be accessed while executing the application service's runtime artifacts. The runtime artifacts are stored in a runtime artifact access 155 module. The DSEI 115 also includes a generic data persistence 160 module that provides data storage for the extension application service. The generic data persistence 160 module enables CRUD (create, retrieve, update, delete) functions for the generic persistence entities. The CRUD functions are accessible via Web technologies such as HTTP, REST, etc.

In various embodiments, the DSEI 115 is a Web enabled infrastructure. This means that users can directly consume services that are developed on the cloud platform 110 from an application. The application is the entry point for a user to consume a service. The application has an URL that can be registered in the service registry 140. A client application can directly access the DSEI 115 over the Internet and load the runtime artifacts to execute the service. The Web enablement is automatically defined and thus, no additional service exposure to the Web is necessary.

Further, in various embodiments, during design time, a user can work on one file at a time from the design time artifacts stored in the resource file storage 150 module. The resource files are located in resource file storage 150 module of the DSEI 115 of the application server. However, in some embodiments, a user (e.g., a developer) may mount a local copy of the resource files in the DSEI 115 to the user's local system, where the user is developing applications and service extensions. Using Web protocols such as WebDav protocols, the user can get an URL of a file. WebDAV is a protocol defining a schema that works on files. Basically, the WebDAV folder can be mounted on an operating system file system and each resource represents a file that has an URL, which can be entered in a Web browser. In this way, a direct view of the application framework is obtained and displayed in the Web browser. Then, the user can download a local copy of the design time resource files. If some modifications on the local copy of the resource files are performed, after a save operation on the files, these modifications are automatically directly synchronized with the original resource files in the DSEI 115. The direct synchronization is possible due to working with the DSEI 115 in a cloud environment.

In other embodiments, the user may mount a local copy of the application server file system to a development editor (e.g., Eclipse), enabling a direct management on the resource files. Analogously, upon saving the edited files, these files are automatically synchronized with resource files in the resource file storage 150 module. In addition, the files that are open for design time editing may not be active for runtime execution. The inactive files may be accessed for read-only operations. The inactive files will become active after synchronization between the local file system copy and the cloud application server file system. After synchronization, the resource files in the cloud application server file system are updated by using the resource files of the local copy.

FIG. 2 is a block diagram illustrating a detailed architectural view of a DSEI 115, according to an embodiment. System 200 illustrates the architectural elements of DSEI 115 in accordance with design time and runtime point of view. System 200 includes design time 210, design time 220, and runtime 230. Design time 210 includes service application framework components needed for creating an application. Initially, an application instance is created. The application instance may be of type service 125, news feed 130, or some other type. Each extension application of type service registers a service in the service registry. The service application is the entry point for all clients of the application to retrieve the service list and service definition. The architectural components of design time 210 include application instance 202, application data transfer object (DTO) 205, and application files 215. In some embodiments, there may be services for internal use only and the application provider may not want to expose these services to the public. Application DTO 205 is an application object that maps a subset of services from the set of services available in the service registry for internal use. In addition, a work center 212 is included. A work center is a module, where each user can configure the views he or she want to see from an application. In addition, that user can only have the views that the user is authorized for on an application in his work center.

Application resource files can be stored for an extension application. These application files 215 are of types conforming to the Web technology development specification, e.g. HTML, JavaScript files and resources such as images. The application files 215 may include, but are not limited to, resource files such as index.html 235, image files such as default.png 240, and manifest.mf 245 file. The manifest.mf 245 file includes metadata and descriptive information (documentation) about the application such as application properties (e.g., author name, company name, etc.), overwriting defaults, dependencies with other files, usage of data services and persistency entities, and so on. The index.html file represents the starting point of the service application; the service application's URL points to this file. The image file may be an image or icon to be displayed at client side to show the extension service in a service gallery. The index.html 235, default.png 240, and manifest.mf 245 file are created during application creation time. However, during design time, more application files can be created. The application files 215 are stored in a document server 225. The document server 225 also provides indexing and searching of the application files. Further, the design time 210 system includes common static libraries 255 of different Web technologies such as JavaScript, HTML, etc. used by the DSEI 115.

In various embodiments, the DSEI 115 is running on a hosted cloud platform. In some embodiments, the users may access the DSEI 115 locally from a Web browser via remote services such as the REST 145 protocol services. Basically, it is possible to create an application file using the REST 145 protocol services within the Web browser. The user may create some application files, for example, an HTML page header, set up some metadata and documentation for the application, build up an UI for the application, and so on. In other embodiments, the application files 215 may be accessed from a user's local file system via file system WebDav 250 by mounting a copy of the application server file system to the local files system of the user. In this way, the user may work locally in a development environment to create or edit resource files via REST 145 services. The file system WebDAV 250 provides access to create, retrieve, update and delete resource files, provided in a folder structure. As mentioned above, the edited local files are directly synchronized with the files in the DSEI 115 of the application server, as the user works in the cloud. In addition, Web application REST services 260 are the entry point for enhancing or using already existing applications on the application server. Web application REST services 260 provide access to the different common application services for consuming such as a security service. In this way, more integrated applications can be created, instead of standalone applications.

Design time 220 system represents the components included in generic data persistency 160. In various embodiments, REST 145 services and generic persistency can be used to create application entities 265 during design time of the application. An application entity is a generic data container that is composed out of a set of application entity fields 270. An application entity field may contain a data value of type Integer, String, or other. The application entity field may also contain a reference to another entity. Application entity 265 and application entity field 270 represent the metamodel of the generic data persistency 160. For example, an application may be created to store user's family data. In this case, the application entity is a family member and the application entity fields may be name, age, relationship, and so on. These, application entity and application entity fields, define the metamodel. The metamodel may be defined via REST 145 interface and some administration UIs during design time. The actual data is stored in the application entity data 275 and application entity field data 280. The application entity data 275 and application entity field data 280 may be created during runtime. For example, for an application entity “family member”, the application entity data may be “father” and for application entity fields “name”, “age”, “relationship”, the application entity field data may be “Peter”, “51”, “parent”.

Optimizations can be performed for storing data by introducing a column or table for each type to support database features such as join, filter and sort operations. In some embodiments, an application entity DTO 285 is used as an abstract object to consume the application persistence entities. In some embodiments, the application entity DTO 285 may be used for internal consumption only. The application entity DTO 285 may be consumed via REST 145 services. The application entities 265 are automatically Web enabled—a user can create, delete, and update an entity remotely from a Web browser. In various embodiments, transformation of the generic data information to a composed representation, such as JSON or XML, can be executed during access via Web technologies such as HTTP and REST. From an outside Web client perspective, the generic persistence entity looks analogous to a non-generic persistence entity, as the serialization transformation to a String representation is analogous for both types.

In various embodiments, runtime 230 includes a client 290 and a Web browser 295. The Web browser 295 reads the index.html file 235 from application files 215. As described above, the index.html file 235 is the starting point of the application. The application's URL is registered in the service registry 140. This URL points to the index.html file 235. Therefore, a client 290 that browses a service in the service registry can obtain the URL of the service and start the application. During runtime 230, the client can read the application files and execute the application services in a Web browser.

In various embodiments, the DSEI 115 provides security capabilities such as authorization and authentication. Different security roles are established that grant different rights to different users. For example, a security role “developer” may grant access to the design time entities of the DSEI 115. Only developers assigned to a specific application are allowed to maintain the corresponding design time application files and resources. During runtime, the runtime artifacts of an application are accessible for any user that was already authenticated with the cloud platform. Access to data persistency can optionally be restricted to special users, assigned to the extension application service.

FIG. 3 is a flow diagram illustrating a process of enhancing an application service by an organization, according to an embodiment. In various embodiments, application services represent different functionalities as part of cloud applications that are deployed and running on an application server of a cloud platform. The cloud applications and the cloud platform are hosted on a cloud software provider. The cloud applications and the cloud platform are provided remotely to users to consume the cloud applications and applications services in the cloud. The DSEI enables an organization or third party partners to enhance a cloud application by creating extension applications or modifying existing application services. Process 300 illustrates the tasks an organization (such as the city municipality) or a company may perform to enhance a cloud application by modifying an existing application service. At block 310, access to the cloud platform is received for the organization. At block 320, the dynamic service extension infrastructure (DSEI 115) is activated for use by the organization. The DSEI 115 is part of the cloud platform. At block 325, creation of users is requested from the cloud platform by the organization. The users are created with user names and passwords. Different users may have different access rights to the cloud application and the resources provided with the DSEI 115. For example, a user “developer” may be able to create and edit application resource files, while a user “administrator” may be able to review application files and enter some data during runtime of the cloud application.

At block 330, the application server file system is accessed via WebDav protocol. The WebDav protocol provides a set of extensions to the HTTP protocol which allows users to collaboratively edit and manage files on remote Web servers. At block 335, a copy of the application server file system is downloaded to a folder in the organization's file system. Thus, the stored application services in the DSEI 115 are accessible for the organization. At block 340, the resource files of an application service of the cloud application are edited. For example, the organization may perform changes in the manifest file or add a picture file to the application files in the resource file storage. At block 345, the modified resource files of the application service are saved in the local copy of the application server file system. Upon a save operation, an automatic and direct synchronization between the local copy of the application server file system and the original application server file system on the cloud platform is performed. The resource files that were modified in the local copy are updated in the application server file system.

It should be noted that the organization may not only enhance an existing application service by modifying some resource files, but also to create new files in the local copy of the file system. Further, the organization may access the application resource files using REST services (e.g., CRUD services) and to create or modify some of the files directly from a Web browser without the need to download a copy of the application server file system. Since the application services are build using standard Web technologies (such as HTML and JavaScript), no further programming language knowledge is necessary for the creation of new files. The organization itself may easily create new application services or enhance existing ones.

FIGS. 4A and 4B are flow diagrams illustrating a process of creating an application service by a third party partner, according to an embodiment. In some embodiments, the organization may provide third party partners the possibility to create and enhance application services. Process 400 illustrates tasks performed by a third party partner to create an application service. At block 410, access to the cloud platform provided by the organization is requested from the third party partner. After the access is granted, the partner is registered as a user with development rights (e.g., security role “developer”) in the cloud platform, at block 415. In some embodiments, the organization may review the third parties' requests that want to become partners with the organization and develop application services for the organization. At block 420, confirmation from the organization is received for becoming a partner with the organization. At block 425, authorization is received for the partner's user to access and use the DSEI file resources for development.

At block 430, an entry portal (e.g., Web page) is received to access the cloud platform and the DSEI 115. At block 435, the partner is connected to the cloud platform and the DSEI 115 as a “developer” via WebDav protocol services. At block 440, a copy of the application server file system is downloaded into a development environment of the partner. In some embodiments, the copy of the application server file system may be downloaded to the local file system as in process 300. At block 445, an extension application of type service is created. The extension application may also be of other types such as news feed. At block 450, resource files for the extension application service are developed in the development environment. The resource files include, but are not limited to, application files such as index.html 235, image files such as default.png 240, and manifest.mf 245 file. At block 455, a generic persistency metamodel is created. The metamodel may include at least one application entity and at least one application entity field for the application entity.

At block 460, the extension application service is tested in the development environment or in a test environment. During development, the user of the DSEI 115 has the possibility to choose between two development processes: development in a productive system and development in a test system. In a productive system, the DSEI 115 supports versioning and has a status schema to distinguish a draft version still in development and an active version that is visible productively. If a test system is available in the cloud platform infrastructure, the development can be performed and validated there. In various embodiments, a release mechanism is in place, allowing pushing the tested development system into the productive system. Alternatively, an export/import functionality is provided to download and upload the development resources as a package, for example, as an archive file.

At block 465 the extension application service is executed for test purposes. At block 470, the resource files (design time and runtime files) of the extension application service are packed as an archive files and imported in the DSEI. The DSEI 115 automatically updates the service registry with the new application service and the storage units with the resource files and the persistency metamodel. Then, the newly created application service is ready for consumption. It should be noted that this approach may also be performed by the organization itself for creating or enhancing an application service.

FIGS. 5A and 5B are flow diagrams illustrating a process of creating an application service in the DSEI 115, according to an embodiment. In various embodiments, a DSEI 115 is provided with a cloud platform that enables registration of an extension application as a service, storage of application files and development resources, runtime access to runtime artifacts, generic data persistency, Web enablement of application maintenance and persistence access, and so on. An integrated development environment that supports file access may be used for the creation of application service. The DSEI 115 provides a WebDAV folder for each application, so that the user may work on the application files and resources. Application services may be built with standard Web technologies (e.g., HTML and JavaScript) and no further programming language knowledge may be necessary. Any third party library conforming to the Web technology standard can be included. In various embodiments, the DSEI 115 offers built-in support for the most prominent third party libraries that may be used by other partners as well.

For the design time, the DSEI 115 provides management of application and service registration, WebDAV access to application files and resources, user interfaces for application administration and modifications, REST services for automation processes, and so on. For runtime purposes, the DSEI 115 provides a Web browser, where program logic may be executed on a client directly in the Web browser. In addition, URL access to runtime artifacts and resources is also provided. The backend system may be any cloud platform implementing the dynamic service extension infrastructure.

Process 500 illustrates the tasks performed in the DSEI 115 during creation of an application service. At block 515, a request to create users in different security roles is received. The users are created by the cloud platform for a given cloud application. A security role “developer” may be created to grant access to the design time entities of the DSEI 115. Only developers assigned to a specific application are allowed to maintain the corresponding design time application files and resources. During runtime, the runtime artifacts of an application are accessible for any user that was already authenticated with the cloud platform. Access to data persistency, especially on instance level may optionally be restricted generically to special users assigned to the extension application service. At block 520, a request to activate the DSEI 115 for the given user is received.

At block 525, a request to create an extension application of type service is received. An application instance is created by the DSEI 115. The application instance may be of type service 125, news feed 130, or some other type. In this case, the application instance is of type service. At block 530, the created extension application is registered in the service registry 140 of the DSEI as a service (application service). The application service is registered in the service registry with a URL pointing to the index.html file of the application service. The index.html file is the entry point for consuming and executing the application service. At block 535, a plurality of resource files of the application service are stored in the DSEI 115. In some embodiments, the application resource files may be stored in a document server. The application resource files can be accessed during runtime while executing the application runtime artifacts.

At block 540, a generic persistency metamodel is stored in a persistence storage unit in the DSEI 115. The metamodel includes at least one application entity and at least one application entity field for the application entity. Metamodel persistence data for the application service is also stored in the persistence storage unit in the DSEI, at block 545. The metamodel persistence data includes an application entity data and an application entity field data. The metamodel persistence data may be entered during runtime. At block 550, runtime artifacts that provide access to the application service resource files are stored. At block 555, access to the resource files is provided for modification of the resource files. The access may be obtained via WebDav services or REST services provided by the DSEI 115. At block 560, the modified resource files are automatically updated in the DSEI 115.

In various embodiments, the dynamic service extension infrastructure 115 is optimized for real-time provisioning of services. Applications may be provisioned as services without disturbing the normal application execution. Moreover, the application services may be completely modification free. They represent extensions or enhancements that coexist next to other extensions. The lifecycle of an extension application service is lightweight. This means that when adding a new service, the extended cloud application does not need to be redeployed or reinstalled. The service is included into the standard application execution and can also be updated or removed. Persistent data in the extension service is not deleted during reinstallation. Further, the cloud application or the cloud platform upgrades may not affect the DSEI 115 content. On the consumer/client side, the application does not need to be restarted. The extension services are pushed automatically to the client and are provided into the service gallery of the application. Users can directly consume the extension service from the service gallery.

FIG. 6 is a flow diagram illustrating a process of consuming an application service, according to an embodiment. Process 600 illustrates the runtime functionality for consuming an application service in the DSEI 115. At block 620, an application service is searched for in a service gallery of an organization. The service gallery is visible in a Web site of the organization. In some embodiments, the users may look at the service gallery and select a service that the user may want to use. In other embodiments, the user may search for a particular service. In various embodiments, the service is implemented as an application service of a cloud application. At block 630, the Web page of an application service is accessed by a client via a Web browser. At block 640, the application service resource files are read. The application runtime artifacts are executed at block 650 and the application resource files may be accessed for administration.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

FIG. 7 is a block diagram of an exemplary computer system 700, according to an embodiment. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method, the method comprising:
creating an extension application of type service for a cloud application running on an application server of a cloud platform;
registering the extension application as a service in a service registry of a dynamic service extension infrastructure (DSEI) as part of the cloud platform;
storing a plurality of resource files of the extension application in a storage module of the DSEI; and
storing a persistency datamodel of the extension application in a persistency storage unit, wherein the datamodel includes at least one application entity and at least one application entity field for the application entity.

2. The method of claim 1, further comprising:
storing a plurality of runtime artifacts of the extension application; and
providing runtime access to the plurality of resource files during execution of the stored plurality of runtime artifacts.

3. The method of claim 2, further comprising:
providing access to the plurality of resource files for a direct modification from a Web browser via Web protocol services; and
providing a copy of a file system of the application server to a local file system for a non-direct modification of the plurality of resource files.

4. The method of claim 3, further comprising automatically updating the plurality of resource files in the DSEI upon a save operation during the non-direct modification of the plurality of resource files in the local file system.

5. The method of claim 3, further comprising providing the copy of the file system of the application server to a development environment for the creation of the extension application.

6. The method of claim 1, further comprising providing CRUD services for the persistency datamodel, wherein the CRUD services are accessible via standard Web technologies.

7. The method of claim 1, wherein the service is registered in the service registry with a URL pointing to an entry Web page of the extension application.

8. A computer system, comprising:
a processor;
a memory in communication with processor, the memory comprising:
an application server running on a cloud platform;
a dynamic service extension infrastructure (DSEI) as part of the application server, wherein the DSEI provides modules for creating an extension application of type service;
a service registry in the DSEI, wherein the extension application is registered as a service; and
a resource file storage unit that stores a plurality of resource files of the extension application.

9. The computer system of claim 8, further comprising:
a generic data persistency unit that stores a persistency datamodel of the extension application, wherein the persistency datamodel includes at least one application entity and at least one application entity field for the application entity; and
a runtime artifacts unit that stores a plurality of runtime files that when executed provide access to the plurality of resource files.

10. The system of claim 8, wherein the service is registered in the service registry with a URL pointing to an entry Web page of the extension application.

11. The system of claim 9, further comprising a set of CRUD services for managing the persistency datamodel, wherein the CRUD services are accessible via standard Web technologies.

12. The system of claim 8, further comprising a Web browser to access the plurality of resource files for a direct modification via Web protocol services.

13. The system of claim 10, wherein the plurality of resource files comprises:
an index file that represents the entry Web page of the extension application;
a manifest file that provides metadata and descriptive information about the extension application; and
an image file that shows the extension application in a service gallery.

14. The system of claim 8, further comprising a test environment, wherein the plurality of resource files is developed and validated.

15. A non-transitory computer-readable medium storing instructions, which when executed cause a computer system to:
create an extension application of type service for a cloud application running on an application server of a cloud platform;
register the extension application as a service in a service registry of a dynamic service extension infrastructure (DSEI) as part of the cloud platform;
store a plurality of resource files of the extension application in a storage module of the DSEI; and
store a persistency datamodel of the extension application in a persistency storage unit, wherein the datamodel includes at least one application entity and at least one application entity field for the application entity.

16. The computer-readable medium of claim 15, further comprising instructions to cause the computer system to:
store a plurality of runtime artifacts of the extension application; and
provide runtime access to the plurality of resource files during execution of the stored plurality of runtime artifacts.

17. The computer-readable medium of claim 16, further comprising instructions to cause the computer system to:
provide access to the plurality of resource files for a direct modification from a Web browser via Web protocol services; and
provide a copy of a file system of the application server to a local file system for a non-direct modification of the plurality of resource files.

18. The computer-readable medium of claim 17, further comprising instructions to cause the computer system to automatically update the plurality of resource files in the DSEI upon a save operation during the non-direct modification of the plurality of resource files in the local file system.

19. The computer-readable medium of claim 15, further comprising instructions to cause the computer system to provide CRUD services for the persistency datamodel, wherein the CRUD services are accessible via standard Web technologies.

20. The computer-readable medium of claim 15, wherein the service is registered in the service registry with a URL pointing to an entry Web page of the extension application.
